(19) United States
(12) Patent Application Publication
(10) Pub. No.: US 2025/0179732 A1
(43) Pub. Date: Jun. 5, 2025

(54) A PROCESS FOR UPGRADATION OF PAPER PULP QUALITY

(71) Applicant: EXERGY HOLDING AB, Göteborg (SE)

(72) Inventors: Prem Verma, Västra Frölunda (SE); Mattias Drotz, Täby (SE); Manish Verma, Torslanda (SE)

(21) Appl. No.: 18/842,064

(22) PCT Filed: Mar. 2, 2023
(86) PCT No.: PCT/SE2023/050189

§ 371 Date: Aug. 28, 2024

(30) Foreign Application Priority Data
Mar. 4, 2022 (SE) 2250298-3
Jan. 26, 2023 (SE) 2350068-9

(51) Int. Cl. D21C 9/00

(52) U.S. Cl. CPC D21C 9/007

(57) ABSTRACT

Described is a process for upgradation of pulp quality. The process for the upgradation of characteristics bulk and absorption capacity of bleached and non-bleached paper pulp wood and non-wood feedstocks for various applications. The resultant pulp can be utilized in sanitary applications, tissue making, packaging paper, specialty papers, dry and wet molded products, healthcare, food and liquid absorbers and print/publication paper.

### TECHNICAL FIELD OF THE INVENTION

The present invention relates to a process for upgradation of paper pulp quality, such as characteristic bulk and absorption capacity of bleached and non-bleached paper pulp.

### BACKGROUND OF THE INVENTION

Quality of market pulp is determined by different parameters depending upon the final application. For sanitary products like diapers, kitchen, towel, napkin the absorption capacity for a given amount of pulp is important. Bulk is an important parameter for all applications as it is closely related to absorption capacity and softness of the final product. Bulk is also of importance for other paper and board products as it improves the bending stiffness.

Different processes have been suggested in the past to improve the bulk and absorption properties of market pulps. Chemical modification of cellulosic fibers, blending with high absorbent cellulosic material as nanocellulose, and synthetic polymers are examples that have been tested.

The most common drying technique of pulp is air-drying, alternative processes have been evaluated in the past to improve and preserve the bulk and absorption e.g., freeze, and vacuum drying. These processes have their challenges in being implemented on a larger scale, as the drying takes place with significantly less drying content, which is also an expensive process to carry out.

Drying with superheated steam is another drying process that have the possibility to improve the bulk and the absorption capacity, but the research has been very limited especially when it comes to study the final properties of market pulps. Earlier work has reported improved effect on paper and pulp properties with superheated steam drying (McCall J. and Douglas W. J. M. Enhancement of properties of diverse grades of paper by superheated steam drying. In: proceedings at the 14th International Drying Symposium (IDS 2004) Sao Paulo. Brazil, 22-25 of August, BB pp. 1255-1262) wherein the strength properties increased up to 32% for paper and 10% for bulk.

The conventional drying technologies are not necessarily optimal in terms of energy consumption, quality of dried product, safety in operation, ability to control the dryer in the event of process upsets, ability to perform optimally even with large changes in throughput, ease of control, and minimal environmental impact due to emissions or combustion of fossil fuels used to provide energy for drying.

Most drying technologies were developed empirically over sustained periods of time, often by small vendors of drying equipment with little access to research and development (R&D) resources human or financial. They were also designed at a time when energy and environmental considerations as well as quality demands were not very stringent.

Perhaps most processes are already designed and operated at their asymptotic limit of performance. However, if for any reason one aims to exceed the performance of drying pulp in a cost-effective way, there is a need for alternative technologies with a higher asymptotic limit to performance, which is necessarily below the maximum defined by thermodynamic constraints.

In view of the above, there is a need to develop a process for improving paper pulp qualities that can be implemented in small- or large-scale production of market pulp, with no emission and in a cost-effective manner.

### SUMMARY OF THE INVENTION

It is a first objective of the present disclosure to provide a process for upgradation of paper pulp quality.

Another objective of the present disclosure is to provide a pulp demonstrating improved properties such as increased bulk properties and absorption properties.

Another objective of the present disclosure is to provide a process for the upgradation of characteristics bulk and absorption capacity of bleached and non-bleached paper pulp such as mechanical pulp, chemical pulp, thermo-mechanical pulp, chemical thermo-mechanical pulp and dissolving pulp from wood and non-wood feedstocks.

Accordingly, the present disclosure provides a process for upgradation of quality of pulp feedstock wherein the process steps comprising:
i. feeding said pulp wet feedstock into vaporized oxygen free upgradation apparatus at elevated pressure conditions in the range between 0.1 barg to 10 barg,
ii. subjecting said feedstock to super-heated circulating vapor at a temperature in the range 120° C. to 300° C., thereby modifying the properties of said feedstock,
iii. discharging the modified pulp feedstock from said upgradation apparatus when the moisture content of the pulp feedstock is controlled between 5% to 30%,
wherein, said process is characterized by the operating parameters of high temperature and pressure at a short residence time between 2 seconds to 3 minutes.

In another aspect of the present disclosure, the moisture content of the resultant pulp feedstock is controlled between 5% to 30%, preferably 10% to 20%.

In another aspect of the present disclosure, the bulk properties of the resultant pulp feedstock obtained by claimed process is enhanced by 5% to 40%.

In another aspect of the present disclosure, the absorption of the resultant pulp feedstock obtained by the process of the present disclosure is enhanced by 50 to 100%.

In another aspect of the present disclosure, wet feedstock in step (i) is selected from the group consisting wood and non-wood feedstocks.

In another aspect of the present disclosure, the elevated pressure in step (i) is in the range of 0.5 barg to 6 barg, preferably between 2 barg to 4 barg.

In another aspect of the present disclosure, the elevated temperature in step (ii) is in the range of 120° C. to 300° C., preferably in 130° C. to 180° C.

In another aspect of the present invention, the residence time for the feedstock inside the apparatus is between 1 second to 3 minutes, preferably in 10 seconds to 15 seconds.

In another aspect of the present disclosure, the process further comprises extracting moisture from resultant feedstock in the form of vapor from the apparatus.

In another aspect of the present disclosure, the process further comprises circulating vapors inside the upgradation apparatus constantly.

In another aspect of the present disclosure, the process further comprises the constant circulation of vapor by arrangement of one or more circulating fans.

In another aspect of the present disclosure, the process further comprises elevated operating temperatures between 120° C. to 300° C.

In another aspect of the present disclosure, the process further comprises elevated operating temperature between 120° C. to 300° C. by heat exchangers.

In another aspect of the present disclosure, the process further comprises circulating vapor through a combination of conduits.

In another aspect of the present disclosure, the process further comprises:
iv. separating vapors and processed pulp in separator,
V. re-circulating the separated vapor to heat exchangers.

In another aspect of the present disclosure, the upgraded property of the feedstock is achieved by the process defined in claim 1 by the combination of pressure, temperature and short residence time.

In another aspect of the present disclosure, the process is carried out in the upgradation apparatus which consists of a closed, pressurized conveying loop, in which superheated vapor is circulated by means of one or more fans, the conveying loop is fitted with feeding and discharge apparatus, heat exchangers for adding heat and controlling of temperature and water content, a separation apparatus such as cyclone for separation of paper pulp and vapors.

In another aspect of the present disclosure, the upgraded properties of the resultant feedstock increase in bulk, increase in absorption capacity and changes in tensile strength.

In another aspect of the present disclosure, the upgraded and dried feedstock is used in the production of various products including tissue papers, hygiene articles, packaging paper, board, other paper products etc.

In another aspect of the present disclosure, there is provided a tissue paper, hygiene article, packaging paper, board, and other paper products produced by the upgraded and dried feedstock.

In another aspect of the present disclosure, there is provided a process wherein, the upgraded resultant feedstock, finally dried in a PSSD dryer, for example at 2.5 bar, exhibits increased bulk capacity of at least 5%, and increased absorption capacity of at least 50%, compared to a referenced sample which is finally commercially flash dried.

In another aspect of the present disclosure, there is provided a process wherein the upgraded and dried feedstock, is used in the production of various products including tissue papers, hygiene articles, packaging paper, board, other paper products, wherein said products exhibit a bulk capacity of at least 3 cm³/g.

In another aspect of the present disclosure, there is provided a pulp having a moisture content of 5% to 30%, and an absorption capacity of at least 15 g/g. Corresponding to at least a 50% increase compared to traditionally dried pulp.

In another aspect of the present disclosure there is provided a paper product such as tissue paper, hygiene articles, packaging paper, and boards produced by the upgraded and dried feedstock or pulp, wherein said products exhibit a bulk capacity of at least 3 cm³/g. Corresponding to an increase in at least 5% compared to traditionally dried pulp.

### BRIEF DESCRIPTION OF DRAWINGS

FIG. 1 Illustrates an example of an apparatus suitable for manufacturing a pulp of the present disclosure.

FIG. 2 Illustrates a configuration of the apparatus shown in FIG. 1.

### DETAILED DESCRIPTION OF DISCLOSURE

The present invention may be understood more readily by reference to the following detailed description of the invention taken in connection with the accompanying drawing figures, which forms a part of this disclosure. It is to be understood that this invention is not limited to the specific apparatus, process, conditions, or parameters described and/or shown herein and that the terminology used herein is for the example only and is not intended to be limiting of the claimed invention. Also, as used in the specification including the appended claims, the singular forms ‘a’, ‘an’, and ‘the’ include the plural, and references to a particular numerical value includes at least that value unless the content clearly directs otherwise. Ranges may be expressed herein as from ‘about’ or ‘approximately’ another value when such a range is expressed another embodiment. Also, it will be understood that unless otherwise indicated, dimensions and material characteristics stated herein are by way of example rather than limitation and are for better understanding of sample embodiment of suitable utility, and variations outside of the stated values may also be within the scope of the invention depending upon the application.

Embodiments will now be described in detail with reference to the accompanying drawings. To avoid unnecessarily redundancy in the present disclosure, well-known features may not be described or substantially the same elements may not be redundantly described, for example. This is for ease of understanding.

The following description are provided to enable those skilled in the art to fully understand the present disclosure and are in no way intended to limit the scope of the present disclosure as set forth.

The following embodiments and features are combinable with each other, as is evident from the appended claims.

In one embodiment of the present invention, a process for upgradation of paper pulp quality is disclosed herein. The term pulp is also mentioned as feedstock pulp or feedstock.

According to one embodiment of the present invention, the sustainable increase in bulk and absorption capacity of the paper pulp is achieved by the process by the combination of pressure, temperature, and time in a single step.

It is pertinent to note that the bulk of paper is defined as 1/density is defined as producing high bulk paper has an economical advantage for papermakers since less pulp fibres can be used to produce paper at a given thickness. In addition, controlling bulk of a sheet or producing a high bulk sheet is an important technology for specialty paper like filter paper.

Further, market pulp is defined as paper pulp produced by pulp and paper mills for sale to external clients is often termed as market pulp. Paper mills that are integrated mills for production of paper pulp and final products like paper, packaging etc. normally does not produce market pulp as their production is for own consumption.

However, integrated mills with excess pulp production capacity can produce market pulp.

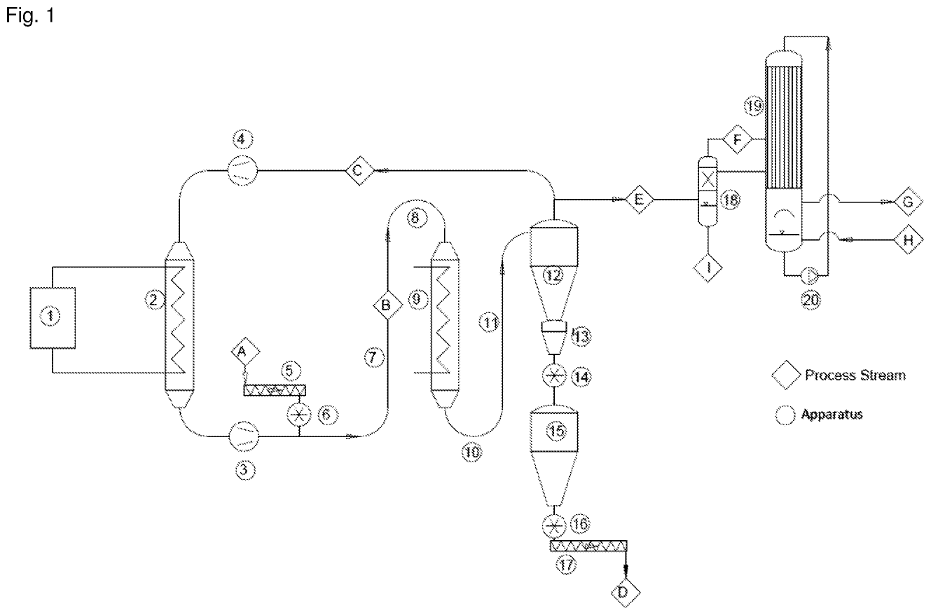

In another embodiment of the present invention, an apparatus suitable for performing the process of the present disclosure is shown in FIG. 1. The apparatus consists of a closed, pressurized conveying loop, in which superheated water vapor is circulated by means of a blower. The conveying loop is fitted with gas tight feeding and discharge apparatus, heat exchangers for adding heat and controlling of temperature and water content, a separation apparatus such as cyclone for separation of paper pulp and vapors. During the process, paper pulp particles are subject to uniform treatment to each particle for homogenous product quality.

In another embodiment of the present invention, the apparatus consists of an arrangement of heat-to-heat exchangers, that are added indirectly from external sources such as high-pressure steam, thermal oil, hot gases, electricity etc, wherein, the amount of heat is carefully controlled to achieve drying of the paper pulp and quality improvements.

According to another embodiment of the present invention, the apparatus as shown in FIG. 1, consists of heat exchangers 2 which are vertical and/or horizontal, circulating fan 4 before heat exchangers 2 and/or circulating fan 3 after heat exchangers 2, feeding cell wheel 6, feeding conveyor 5; drying & transport conduits 7, top connector conduits 8, loop heat exchangers 9, bottom connecting conduits 10, cyclone connecting conduits 11, cyclone separators 12, vortex breaker hoppers 13, discharge cell wheel 14, flash vessel/cooler vessel 15, air lock 16, discharge product conveyor 17.

Further, the heat energy supply apparatus consists of a heat generator 1 and for cleaning of recovered vapors from main apparatus, there may be a vapor scrubber 18 and/or a vapor scrubber 18 and a re-boiler 19 with a circulation pump 20.

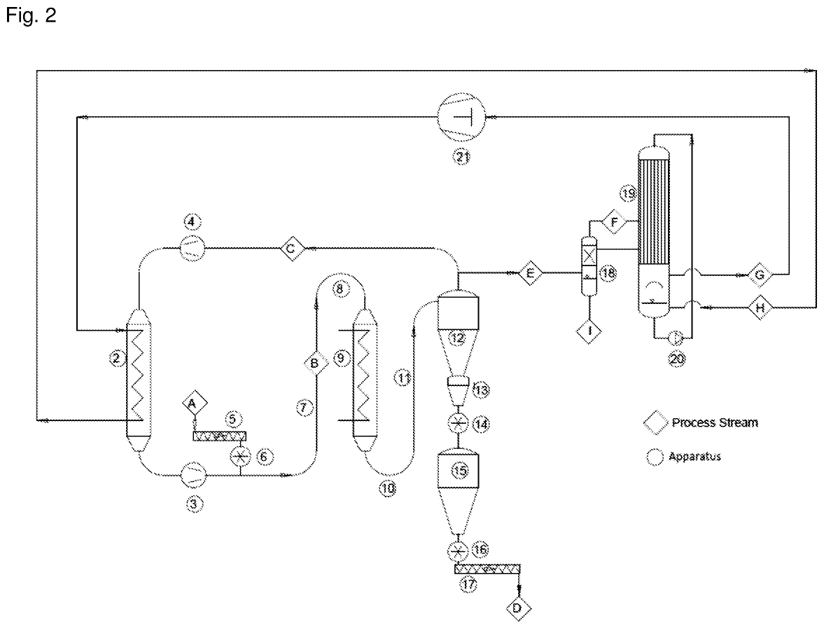

As an alternative to heat generator 1, a mechanical vapor re-compressor 2) may be used as illustrated in FIG. 2.

According to another embodiment of the present invention, the apparatus is 100% closed loop system with no openings to the atmosphere. This means that there is no emission to the atmosphere from the apparatus during operation. The apparatus works at elevated pressures from 0.1 barg to 10 barg. During pressurization of the apparatus, all oxygen is driven out, thereby creating an oxygen free atmosphere inside the apparatus. This eliminates any risk of fire and explosion inside the apparatus, which is very important. Further, feedstock that passes through the apparatus will not get oxidized. The temperature inside the apparatus is in the range of from 120° C. to 300° C.

According to another embodiment of the present invention, vapors inside the apparatus are kept in constant circulation by circulating fan 3 or circulation fan 4 or both circulating fans 3 and 4. Heat energy required by apparatus for modification of feed-stock properties and removal of moisture is added in heat exchanger 2 and heat exchangers 9. In the apparatus there is only one heat exchanger of type 2 or one heat exchanger of type 2 and one or several heat exchangers of type 9. Also, any combination of heat exchangers 2 and heat exchangers 9 can be used. Heat generator 1 can be a steam boiler providing steam heat and/or thermal oil heater and/or hot gas generator using liquid or gaseous fuel providing heat energy to the exchangers 2 and 9. Heat transfer in heat exchangers 2 and 9 is always indirect and heating media is not allowed to mix with vapors being heated inside the apparatus. According to another embodiment of the present invention, wet feedstock A is fed inside the apparatus by conveyor 5 and cell wheel 6. Cell wheel 6 allows the wet feedstock to enter inside the apparatus working at elevated pressure between 0.1 barg to 10 barg. Rotating wings of the cell wheel maintain pressure barrier with minimum leakage of vapors from inside the apparatus. Feed stock once inside the apparatus, meets hot super-heated vapors circulating inside the apparatus at a temperature in the range of from 120° C. to 300° C. Feedstock along with circulating vapors B passes through drying conduits 7, connecting top conduits 8, heat exchangers 9, bottom connecting conduits 10 and conduit connecting to cyclone 11. Feed stock properties are modified and moisture in the feed stock is extracted and converted into vapors inside the apparatus. Feedstock and vapors are separated inside cyclone separators 12 and discharged through vortex breaker hopper 13 and discharge cell wheel 14. Cell Wheel 14 maintains pressure barrier between apparatus and outside atmosphere. Feed stock is now allowed to cool inside the flash vessel/cooler 15 and finally discharged to conveyor 17 via air lock 16. Residence time for feedstock inside the apparatus is between 1 second to 30 seconds. Feedstock stays inside the apparatus for 1 to 30 seconds. Combination of pressure, temperate and short residence time instantly modifies feedstock properties. Most significant modifications achieved are increase in bulk, increase in absorption capacity and changes in the tensile strength.

Modified and dried feedstock D is ready for use in production of various products like tissue paper, hygiene articles, packaging paper and board, other paper products etc.

According to another embodiment of the present invention, vapors C separated in cyclone separators 12 is re-circulated back to heat exchanger 2 though circulating fan 4 and/or circulating fan 3. This process continues as continuous process. As more wet feed stock is processed, more vapors are generated inside the apparatus and pressure increases as whole apparatus has fixed volume. In order to maintain constant pressure between 0.1 barg to 10 barg inside the apparatus, part of the vapors is released as recovered vapors E. Recovered vapors mainly consist of moisture from feedstock and some particulate matter along with volatiles from feedstock. These vapors can be used in other industrial processes for heating, power generation in condensing turbine or ORC systems, district heat production, CO₂ capture or any other purposes. Vapors can be cleaned from dust particles in a wet scrubber 18 and used as clean vapors F. Generated vapors can also be used to generated clean steam G using clean condensate H and used in steam turbines or other processes. Condensed vapors I are used in scrubber 18 to clean generated vapors and is available as liquid phase. When removing water vapors in the apparatus, this liquid phase is available as liquid water. The apparatus helps in reducing water footprint by recovery of feedstock moisture as liquid water. Vapors may also consist of other valuable aromas or chemicals and can be recovered and used/reused.

According to another embodiment of the present invention, clean steam G can be compressed in a mechanical vapor re-compressor 21 to increase pressure of clean steam from 7 barg to 50 barg and condensed in heat exchanger 2 and/or heat exchangers 9 to transfer required heat energy for operating the apparatus. Only electrical energy is needed to operate mechanical vapor re-compressor 21. Mechanical vapor re-compressor 21 eliminates need of thermal energy from heat generator 1. The apparatus with mechanical vapor re-compressor 21 becomes 100% electrified process with no need for thermal energy.

According to another embodiment of the present invention, paper pulp temperature is increased momentarily to 130° C. to 180° C. and pressure 0.5 barg to 6 barg, preferably 2 barg to 4 barg. The temperature is maintained for a period of 2 seconds to 3 minutes, preferably 10 to 15 seconds. Increase in temperature and pressure is obtained by allowing paper pulp to be contacted with water vapors at pressure 0.5 to 6 barg.

According to another embodiment of the present invention, the paper pulp moisture is controlled between 10% to 20% at the end of the process by evaporating water from paper pulp which has moisture 80% to 60% at the inlet of the apparatus.

The apparatus shown in FIG. 1 consists of a closed, pressurized conveying loop, in which superheated water vapor is circulated by means of a blower. The conveying loop is fitted with gas tight feeding and discharge apparatus, heat exchangers for adding heat and controlling of temperature and water content, a separation apparatus such as cyclone for separation of paper pulp and water vapors.

During the process, paper pulp particles are subject to uniform treatment for homogenous product quality.

The paper pulp temperature is increased momentarily to 130° C. to 180° C. The pressure is increased momentarily to 0.5 barg to 6 barg, preferably 2 barg to 4 barg. The temperature and pressure are maintained for a period of 2 seconds to 3 minutes, preferably 10 to 15 seconds. Increase in temperature and pressure is obtained by allowing paper pulp to be contacted with water vapors at pressure of 0.5 to 6 barg.

The paper pulp moisture is controlled between 10% to 20% at the end of the process by evaporating water from paper pulp which has moisture 80% to 60% at the inlet of the apparatus.

The experimental data used in the present process is shown in Table 1.

TABLE 1
Process and experimental data

| | | | | Bleached | Bleached |
|---|---|---|---|---|---|
| | | | | Softwood | Hardwood |
| Paper pulp | Unit | CTMP | CTMP | Kraft Pulp | Kraft Pulp |
| Inlet T | ° C. | 30.8 | 30.8 | 29.8 | 29 |
| Inlet water content | % | 87 | 87 | 49 | 50 |
| Pressure | Barg | 0.5 | 2.5 | 2.5 | 2.5 |
| Inlet T of water vapors | ° C. | 227 | 236 | 235 | 230 |
| Residence time | S | 8-10 | 8-10 | 10-15 | 9-12 |
| Outlet t of vapors | ° C. | 190 | 216 | 220 | 210 |
| Outlet moisture | % | 8 | 6 | 3.7 | 5 |
| content | | | | | |

Table 1. T is temperature and CTMP means chemi-thermo mechanical pulping.

Analysis of the results of the paper pulp and sheets of the present disclosure is shown in Table 2A and B.

TABLE 2A
Pulp properties

| Paper pulp | Absorption |
|---|---|
| BSKP, CTMP, BHKP | +50-150% |

TABLE 2B
Pulp properties after making sheet from pulp

| Paper pulp | Bulk |
|---|---|
| BSKP, CTMP, BHKP | +5-40% |

Here, bleached softwood kraft pulp is abbreviated as BSKP, bleached Hardwood Kraft Pulp is abbreviated as BHKP, and chemi-thermo mechanical pulping is abbreviated as CTMP. Pressurized Superheated Steam Dryer is abbreviated PSSD.

Tables 2A and B demonstrate the improved properties of the present pulp (A) and the sheets made from the pulp (B). The absorption properties of the resultant pulp are improved by 50% to 150%, depending on the source of the pulp and process parameters. In addition, the tensile strength of the resultant pulp found to increased or decreased depending upon the process parameters. Further, the resultant sheets made from the pulp demonstrate increased bulk properties between 5% to 40%. Other paper pulp characteristics are maintained and there is no degradation of the paper pulp manufactured by the process disclosed here, which is an advantage because of the optimum process parameters.

As shown in Table 3, the pulp of the present disclosure exhibits 2 to 4 times higher absorbance when Northern Bleached Softwood Kraft (NBSK) is used, and at least 1.5 times higher absorption when finally dried in a PSSD dryer (inventive sample) compared to the reference samples finally dried in a commercial cylinder dryer. The absorption capacity of the pulp is at least 15 g/g, and between 5-12 g/g for the reference sample.

The data is demonstrated for pulp (Table 3) and for sheets (Table 4), such as a cardboard product, below.

TABLE 3
Pulp absorption

| | | Gravimetric | Increased |
|---|---|---|---|
| | | determination | absorption in |
| | | of absorption | relation to |
| | | for pure pulp | reference |
| Pulp | Description | (g/g). | (times). |
| NBSK | Reference finally dried in | 5-6 | |
| (1) | a commercial cylinder | | |
| | dryer. | | |
| | Pulp taken before | 20-25 | 4 |
| | commercial dryer and | | |
| | finally dried in a PSSD | | |
| | dryer at 2.5 bar. | | |
| NBSK | Reference finally dried in | 8-10 | |
| (2) | a commercial flash dryer. | | |
| | Pulp taken before | 15-17 | 2 |
| | commercial flash dryer | | |
| | and finally dried in PSSD | | |
| | drier at 2.5 bar. | | |
| CTMP | Reference finally dried in | 10-12 | |
| | a commercial flash dryer. | | |
| | Pulp taken before | 15-20 | 1.5-2 |
| | commercial flash dryer | | |
| | and finally dried in PSSD | | |
| | dryer at 2.5 bar. | | |

Table 4 below shows the bulk capacity of sheets (60 g/m²) manufactured from the pulp of the present disclosure (Table 3). The sheets exhibit an increase bulk capacity compared to the reference sample.

TABLE 4
Bulk of manufactured sheets

| | | | Increase |
|---|---|---|---|
| | | Determination | of bulk in |
| | | of bulk for 60 | relation to |
| | | g/m² laboratory | reference |
| Pulp | Description | sheet (cm³/g) | (wt %) |
| NBSK | Reference finally dried in a | 2.2 | |
| (1) | commercial cylinder dryer. Re- | | |
| | slushing and manufacturing of | | |
| | 60 g/m² sheets. | | |
| | Pulp removed before | 3.2 | 45 |
| | commercial drying and finally | | |
| | dried in PSSD dryer at SEAB | | |
| | at 2.5 bar. Re-slushing and | | |
| | manufacturing of 60 g/m² | | |
| | sheets. | | |
| NBSK | Reference finally dried in | 2.6 | |
| (2) | commercial flash dryer. Re- | | |
| | slushing and manufacturing of | | |
| | 60 g/m² sheets. | | |
| | Pulp removed before | 3.1 | 20 |
| | commercial flash dryer and | | |
| | finally dried in PSSD dryer at | | |
| | SEAB at 2.5 bar. Re-slushing | | |
| | and manufacturing of 60 g/m² | | |
| | sheets. | | |

The pulp was partly dried directly in the factory for each case with the dryer that was available (reference sample), thereafter the pulp was taken out to be completely dried in the PSSD dryer (inventive sample) as described under material and methods. All masses were re-slushed in water and shaped, pressed and dried in the lab to 60 g/m² sheets. As shown in table 4, the sheet of the present disclosure finally dried in PSSD dryer exhibits 20 to 45% higher bulk. The bulk capacity of a product produced by the pulp presented here is at least 3 cm³/g and 2.2 to 2.6 for the reference sample, when using NBSK compared to the reference finally dried in a commercial cylinder dryer.

A pulp finally dried by using a PSSD dryer can advantageously be used directly in any product wherein a high absorption capacity is important. The pulp exhibits 1.5 to 4 times higher absorption compared to the reference sample, and the product manufactured by using the pulp, exhibits 20-45% increased bulk capacity compared to the reference sample.

The apparatus has no emissions to atmosphere, no risk for fire and explosion and is most environmentally friendly and energy efficient solution.

The process disclosed here can be used for number of commercially important applications such as mechanical pulp, chemical pulp, thermo-mechanical pulp, chemical thermo-mechanical pulp and dissolving pulp from wood and non-wood feedstocks for applications for sanitary applications, tissue making, packaging paper, specialty papers, dry and wet molded products, healthcare, cardboard products, food and liquid absorbers and print/publication paper.

The resultant pulp from the above-mentioned process can be applied in a range of paper products such as sanitary applications, tissue making, packaging paper, specialty papers, dry and wet molded products, healthcare, cardboard products, food and liquid absorbers and print/publication paper.

1. A process for upgradation of quality of pulp feedstock wherein the process steps comprising:
i. feeding said pulp wet feedstock into a vaporized oxygen free apparatus at elevated pressure conditions in the range between 0.1 barg to 10 barg,
ii. subjecting said feedstock to super-heated circulating vapor at a temperature in the range from 120° C. to 300° C., thereby modifying the properties of said feedstock,
iii. discharging the modified pulp feedstock from said upgradation apparatus when the moisture content of the pulp feedstock is controlled between 5% to 30%,
wherein, said process is characterized by the operating parameters of high temperature and pressure at a short residence time between 2 seconds to 3 minutes.

2. The process according to claim 1, wherein the moisture content of the resultant pulp feedstock is controlled between 5% to 30%.

3. The process according to claim 1, wherein the bulk properties of the resultant pulp feedstock obtained by the process is enhanced by 5% to 40%.

4. The process according to claim 1, wherein the resultant pulp feedstock has an enhanced absorption by 50% to 150%.

5. The process according to claim 1, wherein said pulp wet feedstock in step (i) is selected form the group consisting wood and non-wood feedstocks.

6. The process according to claim 1, wherein the elevated pressure in step (i) is in the range of 0.5 barg to 6 barg.

7. The process according to claim 1, wherein the elevated temperature in step (ii) is in the range of from 120° C. to 300° C.

8. The process according to claim 1, wherein, the residence time for the feedstock inside the apparatus is between 1 second to 3 minutes.

9. The process according to claim 1, wherein the process further comprises extracting moisture from resultant feedstock in the form of vapor from the apparatus.

10. The process according to claim 1, wherein the process further comprises circulating vapors in the internal area of the apparatus constantly.

11. The process according to claim 1, wherein the process further comprises the constant circulation of vapor by arrangement of one or more circulating fans.

12. The process according to claim 1, wherein the process further comprises elevated operating temperature such as temperature in the range of from 120° C. to 300° C., by heat exchangers.

13. The process according to claim 1, wherein the process further comprises circulating vapor through a combination of conduits.

14. The process according to claim 1, wherein the process further comprises the steps of
iv. separating vapor in a separator,
v. re-circulating the separated vapor to heat exchangers.

15. The process according to claim 1, wherein the process is carried out in an apparatus comprising a closed, pressurized conveying loop, in which superheated water vapor is circulated by means of a blower, the conveying loop is fitted with feeding and discharge apparatus, heat exchangers for adding heat and controlling of temperature and water content, a separation apparatus such as cyclone for separation of paper pulp and water vapors.

16. The process according to claim 1, wherein, the upgraded resultant pulp feedstock, finally dried in a PSSD dryer exhibits increased absorption capacity of at least 50%, compared to a referenced sample finally commercially flash dried.

17. The process according to claim 1, wherein, the upgraded and dried pulp feedstock is used in the production of various products including tissue papers, hygiene articles, packaging paper, board, other paper products, wherein said products exhibit a bulk capacity of at least 3 cm³/g.

18. A pulp feedstock having a moisture content of 5% to 30%, and an absorption capacity of at least 15 g/g.

19. A paper product such as tissue paper, hygiene articles, packaging paper, and boards produced by the upgraded and dried pulp feedstock produced according to claim 1, wherein said products exhibit a bulk capacity of at least 3 cm³/g.
